(19) United States
(12) Patent Application Publication
(10) Pub. No.: US 2026/0058585 A1
(43) Pub. Date: Feb. 26, 2026

(54) CONTROL METHOD FOR ELECTRONICALLY COMMUTATED FANS AND DEVICE THEREOF

(71) Applicant: Chip-GaN Power Semiconductor Corporation, Hsinchu City (TW)

(72) Inventor: Sheng-Yu Peng, Hsinchu City (TW)

(21) Appl. No.: 18/810,718

(22) Filed: Aug. 21, 2024

(51) Int. Cl. H02P 23/26; F04D 27/00; H02P 23/14; H02P 25/03; H02P 27/08

(52) U.S. Cl. CPC H02P 23/26; F04D 27/004; H02P 23/14; H02P 25/03; H02P 27/08

(57) ABSTRACT

A control method for an electronically commutated fan is provided, including: calculating a frequency difference between an alternating direct current voltage and a phase signal; converting the frequency difference into a rotational speed command signal; performing modulation on the rotational speed command and the alternating direct current voltage to generate a frequency command signal; phase-adjusting a motor current to generate a phase-modulated current signal; calculating a current difference between the phase-modulated current and the frequency command; generating a pulse width modulation based on the current difference command; generating the phase signal and a plurality of motor control signals according to the pulse width modulation command and a Hall signal. The present invention also provides a control device for an electronically commutated fan, to be disposed between a rectifier and a motor of an electronically commutated fan, which can improve the power factor of the system.

### BACKGROUND OF THE INVENTION

### 1. Field of the Invention

The present invention relates generally to a control method for electronically commutated fans and device thereof.

### 2. The Prior Arts

The alternating current (AC) induction motor of a traditional AC fan is powered by AC input voltage, and generates magnetic field rotation through the induced current on the rotor. However, the AC motor speed is fixed by the power frequency, such as 60 Hz, so the motor has a maximum speed can only reach 3600 rpm. On the other hand, direct current (DC) fans, especially the popular Brushless DC Motor (BLDC), rely on a rotor with permanent magnets and a stator with coils. The rotation of the DC motor is controlled by a controller to switch the phase in the coil to keep the motor continuously rotating, which has the advantage of high efficiency and speed control. Generally speaking, AC motors are less energy efficient than DC motors, and DC motors are generally about 30% more efficient than AC motors.

An electronically commutated fan (EC Fan), which has become increasingly popular in recent years, uses a technology that combines AC fans and DC fans. The EC fan operates with DC voltage and inputs AC power. In other words, this type of fan usually uses 110/220V AC power, and the EC fan uses an embedded electronic driver board to convert AC power to DC power and control the operation of the BLDC motor to control the fan speed.

EC fans have the following advantages: First, the stator is controlled by the driving control board, so no power is wasted. Compared with known technologies, the efficiency of AC shaded-pole motors usually ranges from 15 to 25%, the range of capacitor motors can reach 30 to 50%, and the efficiency of EC motors can reach 60 to 75%. Furthermore, the input voltage is AC power, and the power source is stable. Finally, the EC motor has the controllability of a DC motor, so the EC motor has the option of speed control. In contrast, although AC motors can provide various speeds by adding external speed controllers, this will change the input sine wave and reduce the life of the appliance.

Basically, EC fans can achieve high-efficiency, variable-speed operation while having the advantages of low noise and high energy efficiency of DC fans. For this reason, EC fans are widely used in a variety of applications, including HVAC systems, refrigeration, cooling and other fan applications that require variable speed and high efficiency.

However, in order to improve the energy efficiency of EC fans, EC fans are often used in combination with power factor correction (PFC) modules. The PFC module is a part of the power system and is used for power factor correction. The function of PFC module is to improve the power factor of the power system to ensure that the phase relationship between current and voltage is appropriate and the power factor is close to 1. In other words, the PFC module reduces the phase difference between voltage and current by making the phase angle close to 0°, so that the apparent power is close to the effective power, while the harmonic currents are suppressed. Harmonic suppression has classified limits and stipulated the maximum rated harmonic current in the international standard IEC61000-3-2 to reduce the load on the power grid, with the purpose of improving the apparent power to actual power ratio. In terms of regulations, relevant regulations have also been formulated that require PFC when the power input power exceeds 75 W.

Generally, four wirings are required between the driving controller, pre-driving stage and power stage of SBLDC to transmit control signals. FIG. 1A shows a control schematic view of a conventional BLDC motor. FIG. 1B shows the truth table of the control signal of FIG. 1A and corresponding motor control phase. FIG. 1C shows a waveform of the control signal of FIG. 1A. As shown in FIGS. 1A, 1B, and 1C, the BLDC controller 101 outputs control signals AH, AL, BH, and BL to a pre-driving stage 102, and then the pre-driving stage 102 converts the received control signals AH, AL, BH, and BL into S1, S2, S3, and S4 output used to control the four transistors of the power stage 103; wherein, PH1 and PH2 are phase signals of different phase states of the motor M, VA and VB represent the potentials of points A and B respectively, and HAL is the Hall signal of the motor M, which is fed back to the BLDC controller 101. The truth table in FIG. 1B lists the states of the control signals AH, AL, BH, BL and the corresponding output signals S1, S2, S3, S4, as well as the waveforms of each signal under the phase signals PH1 and PH2 in different phase states. AL and BL of FIG. 1C are pulse-width modulation (PWM) used to control the speed of the motor M, with the duty cycle range between 0-100%. The example of the control waveform shown in FIG. 1C is 50%.

FIG. 2 shows the driving architecture of a conventional EC fan, in which an AC power supply drives and controls the power stage through a rectifier 201, a PFC module 202, a BUCK module 203, and a BLDC 204, to drive a motor 205. Wherein, BUCK module 203 is a direct current/direct current (DC/DC) power converter, which is a buck converter, whose main function is to reduce the input voltage to a lower output voltage.

It is worth noting that in the conventional architecture, a large-capacity capacitor needs to be provided after the PFC module 202 and the BUCK module 203 respectively.

However, the PFC module and the BUCK module used in the conventional technology not only increase the manufacturing cost, but also requires the necessary additional large capacitance, which not only increases the cost, but is also a major obstacle to miniaturization of the control device.

### SUMMARY OF THE INVENTION

A primary objective of the present invention is to provide a control method for electronically commutated fans and device thereof, to improve the power factor of the system by adjusting the frequency and phase synchronization of AC current and voltage.

Another objective of the present invention is to provide a control method for electronically commutated fans and device thereof, which eliminates the PFC module, BUCK module and the large capacitors used in the conventional technology and reduces manufacturing costs.

In order to achieve the aforementioned objectives, the present invention provides a control device for electronically commutated fans, to be disposed between a rectifier and a motor of an electronically commutated fan, and the control device includes: a pre-driving power stage, a BLDC controller, a phase adjustment unit, a frequency difference calculation unit, a speed control unit, and a current control unit; wherein, the pre-driving power stage is connected to the BLDC controller to receive a plurality of motor control signals from the BLDC controller and drive the motor according to the plurality of motor control signals; the BLDC controller receives a Hall signal from the motor to obtain a phase signal, adjusts the phase of a drive current of the pre-driving power stage through the phase adjustment unit according to the phase signal and generates a phase-modulated current; the frequency difference calculation unit calculates an alternating direct current (DC) voltage output by the rectifier and a frequency difference of the phase signal; the speed control unit is to generate a current difference according to the frequency difference, the alternating DC voltage, and the phase-modulated current; the current control unit generates a pulse width modulation command signal according to the current difference and transmits the pulse width modulation command signal to the BLDC controller to generate the plurality of motor control signals.

In a preferred embodiment, the frequency difference calculation unit further includes a first frequency conversion unit, a second frequency conversion unit, and a frequency subtractor; wherein the first frequency conversion unit calculates the frequency transmitted from the rectifier to a first frequency of the alternating DC voltage of the pre-driving power stage, and the second frequency conversion unit calculates a second frequency of the frequency of the phase signal, and the frequency subtractor calculates a frequency difference between the first frequency and the second frequency.

In a preferred embodiment, the speed control unit further includes a speed regulator, a first modulator, and a current subtractor; the speed regulator converts the frequency difference into a rotational speed command signal; the first modulator modulates the alternating DC voltage and the rotational speed command signal into a frequency command signal, and the current subtractor calculates the current difference between the phase-modulated current and the frequency command signal.

In a preferred embodiment, the frequency difference calculation unit further includes a first frequency conversion unit, a second frequency conversion unit, a divider, a frequency subtractor, a multiplier, and a second modulator; wherein the first frequency conversion unit calculates a first frequency of the alternating DC voltage transmitted by the rectifier to the pre-driving power stage, and the second frequency conversion unit calculates a second frequency of the frequency of the phase signal, the divider divides the second frequency, the frequency subtractor calculates the frequency difference between the first frequency and the divided second frequency, and the multiplier converts the alternating DC voltage into an equalized voltage, the second modulator then modulates the equalized voltage and the alternating DC voltage to generate a modulated voltage and then transmits the modulated voltage to the speed control unit, wherein the multiplier and the divider multiply and divide by the same factor.

In a preferred embodiment, the speed control unit further includes a speed regulator, a first modulator, and a current subtractor; wherein the speed regulator converts the frequency difference into a rotational speed command signal; the first modulator modulates the modulated voltage and the rotational speed command signal into a frequency command signal, and the current subtractor calculates the current difference between the phase-modulated current and the frequency command signal.

In a preferred embodiment, the current control unit further includes a third modulator for modulating the pulse width modulation (PWM) command signal with the equalized voltage before transmitting the PWM command signal to the BLDC controller.

The present invention provides a control method for electronically commutated fans, including the following steps: calculating a frequency difference between an alternating DC voltage and a phase signal; converting the frequency difference into a rotational speed command signal; modulating the rotational speed command signal and the alternating DC voltage to generate a frequency command signal; phase-adjusting a motor current to generate a phase-modulated current signal; calculating a current difference between the phase-modulated current signal and the frequency command signal; based on the current difference, generating a pulse width modulation command signal; generating the phase signal and a plurality of motor control signals according to the pulse width modulation command signal and a Hall sensing signal.

In a preferred embodiment, the step of calculating the frequency difference between an alternating DC voltage and a phase signal further includes: converting the alternating DC voltage into a first frequency signal; converting the phase signal into a second frequency signal; and calculating the frequency difference between the first frequency signal and the second frequency signal.

In a preferred embodiment, the control method further includes a frequency division step after the step of converting the phase signal into a second frequency signal, and the frequency division step is to divide the second frequency signal, and then calculate the frequency difference between the first frequency signal and the divided second frequency signal.

In a preferred embodiment, the control method further includes a voltage equalization step after the step of generating the speed command, and the voltage equalization step is to convert the alternating DC voltage into an equalized voltage, and then modulate the equalized voltage and the alternating DC voltage, followed by modulate with the speed command to generate the frequency command signal.

In a preferred embodiment, the control method further includes a modulation step after the step of generating a pulse width modulation command signal, and the modulation step is to modulate the pulse width modulation command signal and the equalized voltage.

The effect of the present invention is that the control method and device for the electronically commutated fan of the present invention can adjust the frequency and phase synchronization of AC current and voltage to improve the power factor of the system and eliminate the PFC modules, BUCK modules and large capacitors used in the conventional technology to reduce manufacturing cost.

### BRIEF DESCRIPTION OF THE DRAWINGS

The present invention will be apparent to those skilled in the art by reading the following detailed description of a preferred embodiment thereof, with reference to the attached drawings, in which:

FIG. 1A shows a control diagram of a conventional BLDC motor.

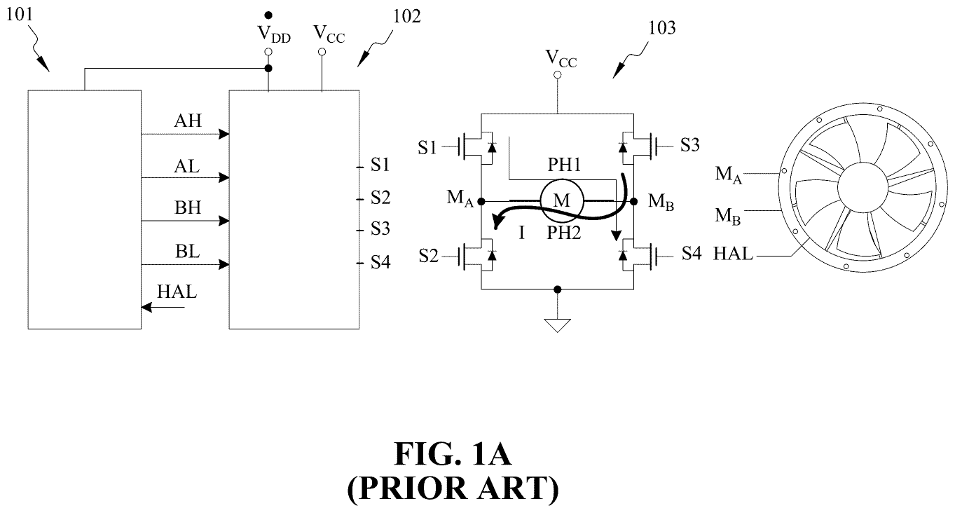

FIG. 1B shows the truth table of the control signal of FIG. 1A and corresponding motor control phase.

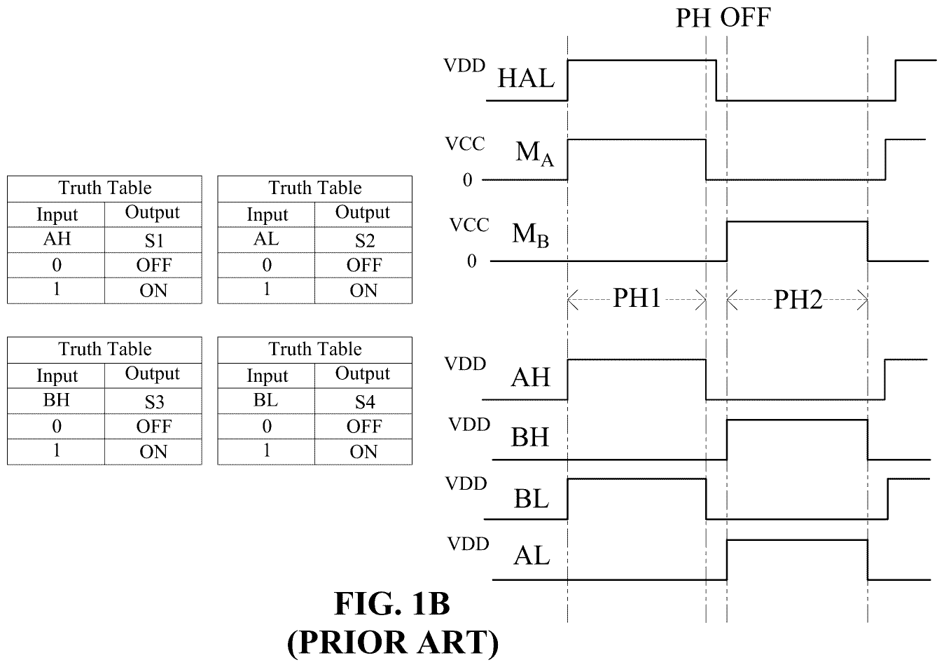

FIG. 1C shows an embodiment of the waveform of the control signal of FIG. 1A.

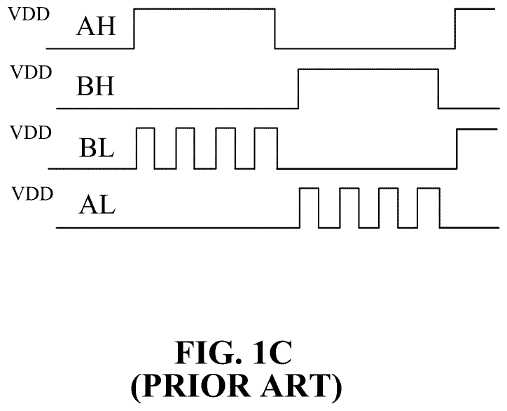

FIG. 2 shows a schematic diagram of the driving architecture of a conventional EC fan.

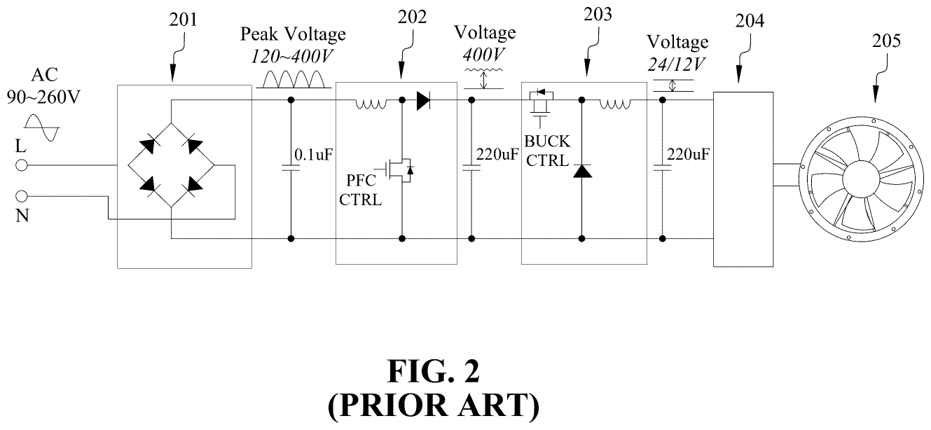

FIG. 3 is a schematic diagram of the driving structure of the electronically commutated fan of the present invention.

FIG. 4 is a schematic structural diagram of the first embodiment of the control device for electronically commutated fan of the present invention.

FIG. 5 is a schematic diagram of a target signal waveform of the first embodiment of control device for electronically commutated fan of the present invention.

FIG. 6 is a schematic structural diagram of the second embodiment of the control device for electronically commutated fan control device of the present invention.

FIG. 7 is a schematic diagram of a target signal waveform of the second embodiment of control device for electronically commutated fan of the present invention.

FIG. 8 is a diagram showing the relationship between the voltage and the factors of frequency multiplication and division in the second embodiment of the control device for electronically commutated fan of the present invention.

FIG. 9 shows a waveform diagram of increasing target voltage and current in the second embodiment of the control device for electronically commutated fan of the present invention.

FIG. 10 is a flow chart of the control method for electronically commutated fan of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

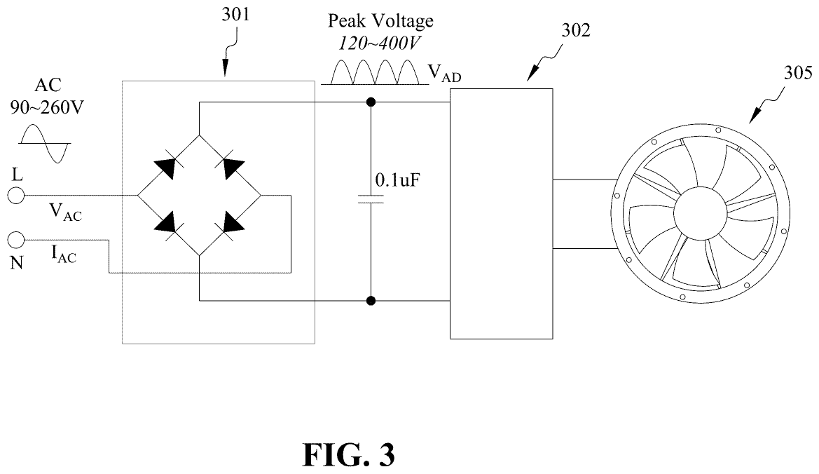

FIG. 3 shows a schematic diagram of the driving structure of the electronically commutated fan of the present invention. As shown in FIG. 3, the present invention provides an electronically commutated fan control device 302, which is disposed between the rectifier 301 and an electronically commutated fan motor 305. The rectifier 301 is connected to an AC power supply, and the voltage and current input by the AC power supply are represented by V_{AC} and I_{AC} respectively. The input alternating current passes through the rectifier 301 to generate an alternating direct current voltage V_{AD} for input to the control device 302 of the present invention, and then the control device 302 generates a driving current I_{M} to drive the motor 305.

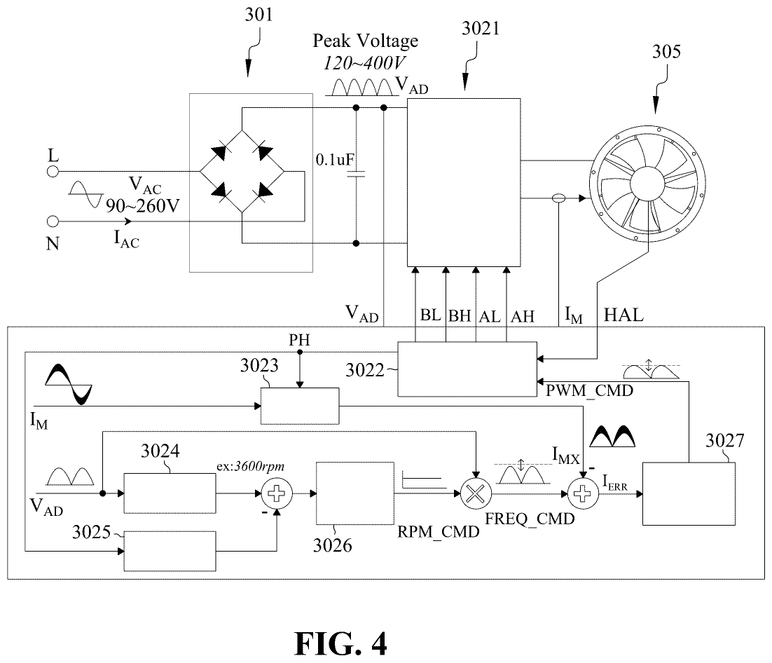

FIG. 4 shows a schematic structural diagram of the first embodiment of the control device 302 for electronic commutation fan of the present invention. As shown in FIG. 4, the control device 302 includes: a pre-driving power stage 3021, a BLDC controller 3022, a phase adjustment unit 3023, a frequency difference calculation unit, a speed control unit, and a current control unit 3027; wherein, the frequency difference calculation unit further includes a first frequency conversion unit 3024, a second frequency conversion unit 3025, and a frequency subtractor; and the speed control unit further includes a speed regulator 3026, a first modulator, a current subtractor. The control device 302 and the motor 305 form a feedback loop, that is, the control device 302 adjusts the driving current I_{M} through a Hall signal (HAL) of the motor 305 to achieve the objective of controlling the electronically commutated fan.

The following describes the structure and function of each component of the present invention:

As shown in FIG. 4, the pre-driving power stage 3021 is connected to the BLDC controller 3022 to receive a plurality of motor control signals BL, BH, AL, AH from the BLDC controller 3022, and based on the plurality of motor control signals BL, BH, AL, AH to drive the motor 305. The BLDC controller 3022 receives a Hall signal (HAL) from the motor 305 to obtain a phase signal PH, and adjusts the phase of a driving current I_{M} of the pre-driving power stage 3021 through the phase adjustment unit 3023 according to the phase signal PH, and generates a phase-modulated current I_{MX}. Since the pre-driving power stage 3021 and the BLDC controller 3022 can adopt any conventional technology, the details will not be described here.

It is worth noting that the objective of the present invention is to eliminate the PFC module and the BUCK module in the conventional technology and achieve the objective of improving the power factor (PF). As mentioned earlier, the PFC module works by ensuring that the phase relationship between current and voltage is appropriate and the power factor is close to 1. In other words, the PFC module reduces the phase difference between voltage and current by making the phase angle close to 0°, so that the apparent power is close to the effective power. Therefore, the function of the phase adjustment unit 3023 is to adjust the phase of the driving current I_{M} using the phase signal obtained from the HAL signal to generate the phase-modulated current I_{MX}, in order to achieve the same phase as the driving voltage.

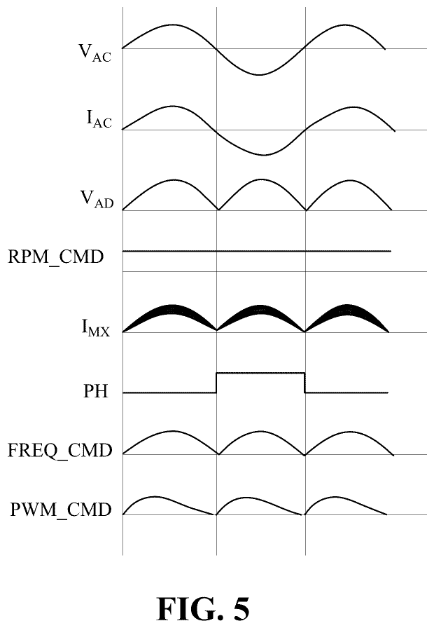

FIG. 5 is a schematic diagram of a target signal waveform of the first embodiment of the control device for electronically commutated fan of the present invention. Refer to FIG. 3, FIG. 4, and FIG. 5. As shown in FIG. 5, in the present embodiment, the goal is to control the driving voltage and driving current of the motor to always maintain the same phase and the same frequency.

The frequency difference calculation unit is used to calculate a frequency difference between the alternating DC voltage V_{AD} output by the rectifier 301 and the phase signal PH. In the present embodiment, the frequency difference calculation unit further includes a first frequency conversion unit 3024, a second frequency conversion unit 3025, and a frequency subtractor. Wherein, the first frequency conversion unit 3024 calculates a first frequency of the alternating DC voltage V_{AD}, and the second frequency conversion unit 3025 calculates a second frequency of the frequency of the phase signal PH; and then the frequency subtractor calculates the frequency difference between the first frequency and the second frequency. In other words, the frequency difference calculation unit is used to calculate the frequency difference between the input voltage (AC voltage V_{AD}) and the phase signal of the motor 305.

Then, the speed control unit generates a current difference I_{ERR} based on the frequency difference, the alternating DC voltage V_{AD}, and the phase-modulated current I_{MX}. In the present embodiment, the speed control unit further includes a speed regulator 3026, a first modulator, and a current subtractor. Wherein, the speed regulator 3026 converts the frequency difference into a rotational speed command signal RPM_CMD, the first modulator converts the alternating DC voltage V_{AD} and the rotational speed command signal RPM_CMD into a frequency command signal FREQ_CMD, and finally, the current subtractor calculates the current difference I_{ERR} between the phase-modulated current I_{MX} and the frequency command signal FREQ_CMD.

Finally, the current control unit 3027 generates a pulse width modulation command signal PWM_CMD according to the current difference I_{ERR}, and transmits the pulse width modulation command signal PWM_CMD to the BLDC controller 3022 to generate the plurality of motor control signals BL, BH, AL, AH. At this point, the correction of the phase and frequency of the driving current and the driving voltage in the control device of the present invention is completed.

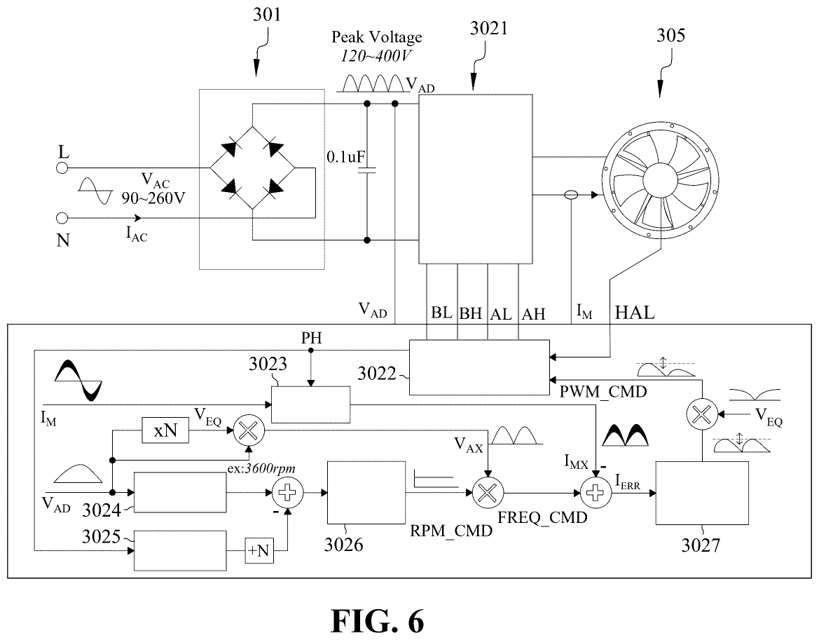

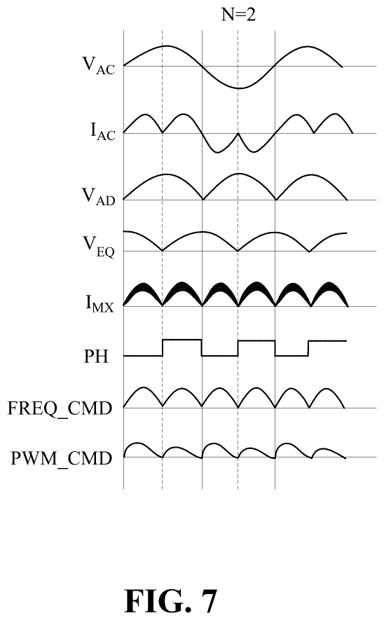

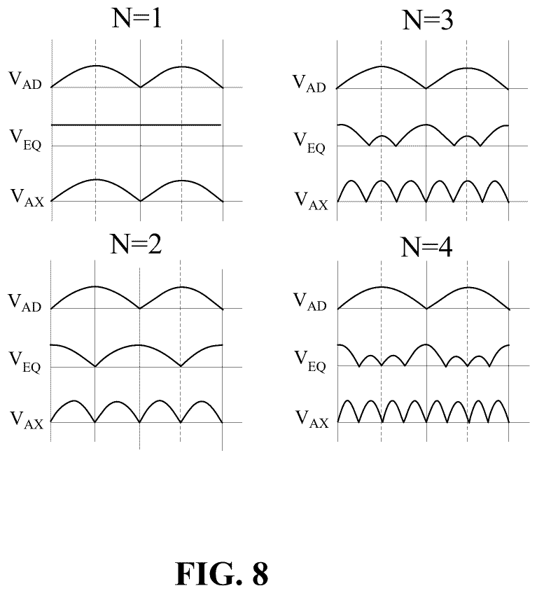

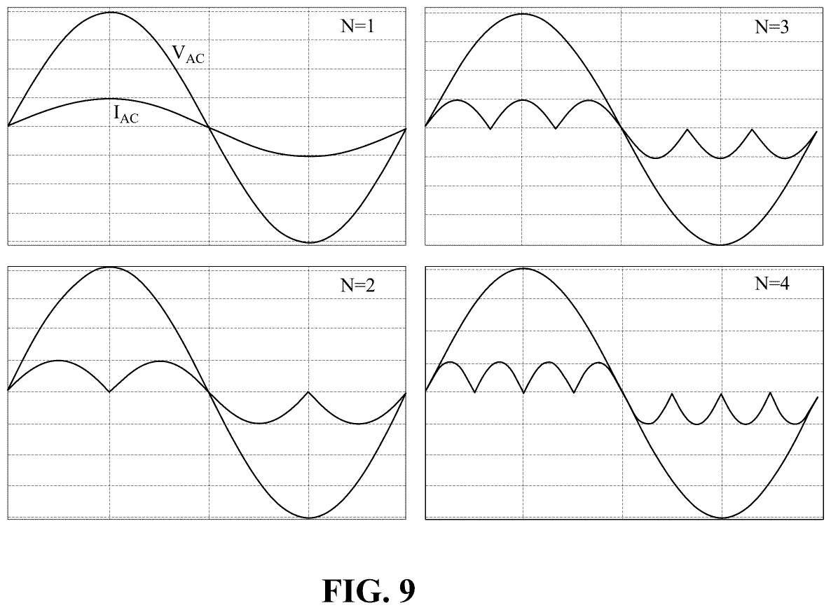

Referring to FIGS. 6-9, FIG. 6 is a schematic structural diagram of a second embodiment of an electronic commutation fan control device of the present invention; FIG. 7 is a schematic diagram of a target signal waveform of the second embodiment of the control device for electronically commutated fan of the present invention; FIG. 8 is a diagram showing the relationship between the voltage and the factor of frequency multiplication and division in the second embodiment of the control device for electronically commutated fan of the present invention; and FIG. 9 shows a waveform diagram of increasing target voltage and current in the second embodiment of the control device for electronically commutated fan of the present invention.

As shown in FIG. 6, the second embodiment of the control device of the present invention is similar to the aforementioned first embodiment. The main difference is that the present embodiment can be applied when the current frequency of the input AC power supply is N times of the voltage frequency, where N is an integer.

Compared with the first embodiment, in the present embodiment, the frequency difference calculation unit further includes a divider, a multiplier, and a second modulator. Wherein, the divider divides the second frequency, and then the frequency subtractor calculates the frequency difference between the first frequency and the divided second frequency; the multiplier converts the alternating DC voltage V_{AD} into an equalized voltage V_{EQ}, the second modulator modulates the equalized voltage V_{EQ} and the alternating DC voltage V_{AD} to generate a modulated voltage V_{AX} and then transmits the modulated voltage to the speed control unit, wherein the multiplication factor of the multiplier and the division factor of the divider are the same.

Similarly, in the present embodiment, the first modulator modulates the modulated voltage V_{AX} and the rotation speed command signal RPM_CMD into a frequency command signal FREQ_CMD, and then the current subtractor calculates the current difference I_{ERR} between the phase current I_{MX} and the frequency command signal FREQ_CMD. The current control unit further includes a third modulator for modulating the pulse width modulation command signal PWM_CMD with the equalized voltage before transmitting to the BLDC controller 3022.

FIG. 7 shows a schematic diagram of the target signal waveform when N=2; FIG. 8 lists the waveform comparison among the alternating DC voltage V_{AD}, the equalized voltage V_{EQ}, and the modulated voltage V_{AX} when N=1, 2, 3, and 4; FIG. 9 shows the waveform diagram of the input voltage and current of the present invention when N=1, 2, 3, and 4. As shown in FIGS. 7, 8, and 9, when the V_{AC} frequency is N times the I_{AC} frequency, the frequency of the modulated voltage V_{AX} is also N times the frequency of the alternating DC voltage V_{AD}.

Table 1 shows the simulation results of the power factor of the second embodiment when N=1, 2, 3, and 4.

TABLE 1

| | N = 1 | N = 2 | N = 3 | N = 4 |
|---|---|---|---|---|
| 2P, RPM | 3600 | 7200 | 10800 | 14400 |
| 4P, RPM | 1800 | 3600 | 5400 | 7200 |
| PF | 1 | 0.848 | 0.827 | 0.820 |

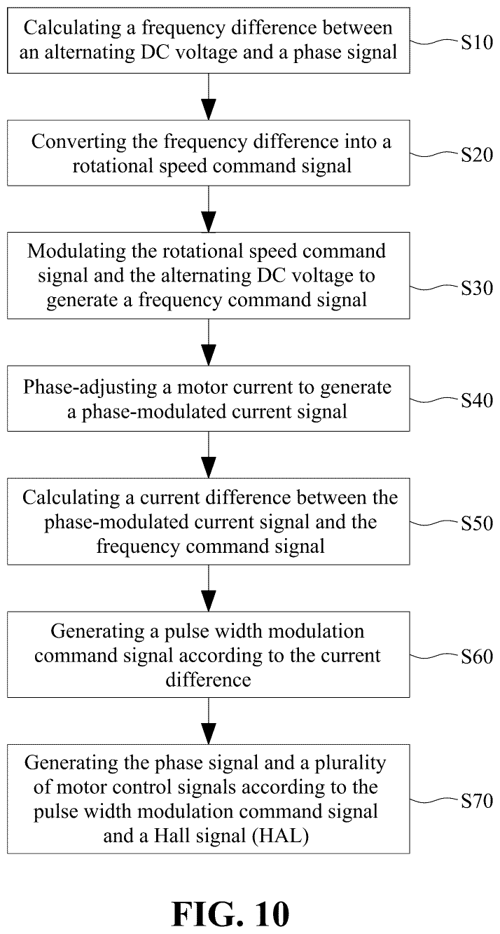

FIG. 10 shows a flow chart of the control method for electronically commutated fan of the present invention. Referring to both FIGS. 4 and 10, the control method for electronically commutated fan of the present invention includes the following steps:
Step S10: Calculating a frequency difference between an alternating DC voltage and a phase signal; specifically, the frequency difference between the alternating DC voltage V_{AD} and the phase signal PH can be calculated through the frequency difference calculation unit in FIG. 4.
Step S20: Converting the frequency difference into a rotational speed command signal; the specific conversion can be implemented through the speed regulator of the speed control unit in FIG. 4.
Step S30: Modulating the rotational speed command signal and the alternating DC voltage to generate a frequency command signal; the specific modulation can be performed through the first modulator of the speed control unit in FIG. 4.
Step S40: Phase-adjusting a motor current to generate a phase-modulated current signal; the specific adjustment can be performed through the phase adjustment unit in FIG. 4.
Step S50: Calculating a current difference between the phase-modulated current signal and the frequency command signal; the specific calculation can be performed through the current subtractor of the speed control unit in FIG. 4.
Step S60: Generating a pulse width modulation command signal according to the current difference; the specific generation method can be executed through the current control unit in FIG. 4.
Step S70: Generating the phase signal and a plurality of motor control signals according to the pulse width modulation command signal and a Hall signal (HAL). The specific generation method can be implemented through the BLDC controller in FIG. 4.

Referring to the second embodiment of FIG. 6, when applied to the aforementioned second embodiment, the control method for electronically commutated fan of the present invention further includes the following steps:
1. The step of calculating the frequency difference between an alternating DC voltage and a phase signal further includes: converting the alternating DC voltage into a first frequency signal; converting the phase signal into a second frequency signal; calculating the frequency difference between the frequency signal and the second frequency signal.
2. After the step of converting the phase signal into a second frequency signal, a frequency division step is further included. The frequency division step is to divide the second frequency signal, and then calculate the frequency difference of the first frequency signal and the divided second frequency signal.
3. After the step of generating the speed command, a voltage equalization step is performed. The voltage equalization step converts the alternating DC voltage into an equalized voltage, and then modulates the equalized voltage and the alternating DC voltage followed by modulating the result with the speed command to generate the frequency command signal.
4. After the step of generating a pulse width modulation command signal, a modulation step is performed that modulates the pulse width modulation command signal and the equalized voltage.

It is worth mentioning that each numerical value used in the present embodiment is used to explain the implementability of the present invention, but the present invention is not limited thereto; the selection of other appropriate numerical values is also within the scope of the present invention.

In summary, the control method and device for electronically commutated fan of the present invention can adjust the frequency and phase synchronization of AC current and voltage to improve the power factor of the system and eliminate the PFC modules, BUCK modules and large capacitors used in the conventional technology to reduce manufacturing cost.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A control device for electronically commutated fans, to be disposed between a rectifier and a motor of an electronically commutated fan, and the control device, comprising:
a pre-driving power stage, a BLDC controller, a phase adjustment unit, a frequency difference calculation unit, a speed control unit, and a current control unit;
wherein, the pre-driving power stage is connected to the brushless direct current motor (BLDC) controller to receive a plurality of motor control signals from the BLDC controller and drive the motor according to the plurality of motor control signals;
the BLDC controller receives a Hall signal from the motor to obtain a phase signal, adjusts the phase of a drive current of the pre-driving power stage through the phase adjustment unit according to the phase signal and generates a phase-modulated current;
the frequency difference calculation unit calculates an alternating direct current (DC) voltage output by the rectifier and a frequency difference of the phase signal;
the speed control unit is to generate a current difference according to the frequency difference, the alternating DC voltage, and the phase-modulated current; and
the current control unit generates a pulse width modulation command signal according to the current difference and transmits the pulse width modulation command signal to the BLDC controller to generate the plurality of motor control signals.

2. The control device for electronically commutated fans according to claim 1, wherein the frequency difference calculation unit further includes a first frequency conversion unit, a second frequency conversion unit, and a frequency subtractor; wherein the first frequency conversion unit calculates the frequency transmitted from the rectifier to a first frequency of the alternating DC voltage of the pre-driving power stage, and the second frequency conversion unit calculates a second frequency of the frequency of the phase signal, and the frequency subtractor calculates a frequency difference between the first frequency and the second frequency.

3. The control device for electronically commutated fans according to claim 1, wherein the speed control unit further includes a speed regulator, a first modulator, and a current subtractor; the speed regulator converts the frequency difference into a rotational speed command signal; the first modulator modulates the alternating DC voltage and the rotational speed command signal into a frequency command signal, and the current subtractor calculates the current difference between the phase-modulated current and the frequency command signal.

4. The control device for electronically commutated fans according to claim 1, wherein the frequency difference calculation unit further includes a first frequency conversion unit, a second frequency conversion unit, a divider, a frequency subtractor, a multiplier, and a second modulator; wherein the first frequency conversion unit calculates a first frequency of the alternating DC voltage transmitted by the rectifier to the pre-driving power stage, and the second frequency conversion unit calculates a second frequency of the frequency of the phase signal, the divider divides the second frequency, the frequency subtractor calculates the frequency difference between the first frequency and the divided second frequency, and the multiplier converts the alternating DC voltage into an equalized voltage, the second modulator then modulates the equalized voltage and the alternating DC voltage to generate a modulated voltage and then transmits the modulated voltage to the speed control unit, wherein the multiplier and the divider multiply and divide by the same factor.

5. The control device for electronically commutated fans according to claim 4, wherein the speed control unit further includes a speed regulator, a first modulator, and a current subtractor; wherein the speed regulator converts the frequency difference into a rotational speed command signal; the first modulator modulates the modulated voltage and the rotational speed command signal into a frequency command signal, and the current subtractor calculates the current difference between the phase-modulated current and the frequency command signal.

6. The control device for electronically commutated fans according to claim 5, wherein the current control unit further includes a third modulator for modulating the pulse width modulation (PWM) command signal with the equalized voltage before transmitting the PWM command signal to the BLDC controller.

7. A control method for electronically commutated fans, comprising the following steps:
calculating a frequency difference between an alternating DC voltage and a phase signal;
converting the frequency difference into a rotational speed command signal;
modulating the rotational speed command signal and the alternating DC voltage to generate a frequency command signal;
phase-adjusting a motor current to generate a phase-modulated current signal;
calculating a current difference between the phase-modulated current signal and the frequency command signal;
based on the current difference, generating a pulse width modulation command signal; and
generating the phase signal and a plurality of motor control signals according to the pulse width modulation command signal and a Hall sensing signal.

8. The control method for electronically commutated fans according to claim 7, wherein:
the step of calculating the frequency difference between an alternating DC voltage and a phase signal further comprises: converting the alternating DC voltage into a first frequency signal; converting the phase signal into a second frequency signal; and calculating the frequency difference between the first frequency signal and the second frequency signal;
further comprises a frequency division step after the step of converting the phase signal into a second frequency signal, and the frequency division step is to divide the second frequency signal, and then calculate the frequency difference between the first frequency signal and the divided second frequency signal;
further comprises a voltage equalization step after the step of generating the speed command, and the voltage equalization step is to convert the alternating DC voltage into an equalized voltage, and then modulate the equalized voltage and the alternating DC voltage, followed by modulate with the speed command to generate the frequency command signal; and
further comprises a modulation step after the step of generating a pulse width modulation command signal, and the modulation step is to modulate the pulse width modulation command signal and the equalized voltage.
